(19) United States
(12) Patent Application Publication
(10) Pub. No.: US 2026/0244495 A1
(43) Pub. Date: Aug. 20, 2026

(54) DYNAMIC HEAP RESIZING FOR JAVA WORKLOADS WITH VERTICAL POD AUTOSCALER

(71) Applicant: CAST AI Group, Inc., Miami, FL (US)

(72) Inventor: Jan Sykora, Prague (CZ)

(21) Appl. No.: 19/292,669

(22) Filed: Aug. 6, 2025

Related U.S. Application Data
(60) Provisional application No. 63/758,370, filed on Feb. 14, 2025.

(51) Int. Cl. G06F 9/50; G06F 9/455

(52) U.S. Cl. CPC G06F 9/5016; G06F 9/45529; G06F 9/505

(57) ABSTRACT

A method for performing dynamic heap resizing in Java workloads, the method comprising allocating, by a processor, a predetermined percentage of system memory as a heap; monitoring, by the processor, memory usage of the heap; and generating, by the processor, Vertical Pod Autoscaler (VPA) recommendations based on the monitored memory usage.

### CROSS-REFERENCE TO RELATED APPLICATIONS

This application claims priority under 35 USC §119(e) to U.S. Provisional Application No. 63/758,370, filed on February 14, 2025, the contents of which are incorporated herein by reference in their entirety.

### BACKGROUND

### Field

The present disclosure relates to memory management in containerized Java applications, and more particularly to dynamic heap resizing for Java workloads using a Vertical Pod Autoscaler (VPA) in container orchestration environments.

### Related Art

Java applications are widely used in enterprise environments, often deployed in containerized environments managed by orchestration platforms like Kubernetes. These applications rely on the Java Virtual Machine (JVM) to manage memory allocation and deallocation, particularly using a heap for dynamic object storage.

Memory management in Java applications presents unique challenges in containerized environments. The JVM traditionally allocates a fixed amount of memory at startup, which may not align well with the dynamic nature of container-based deployments. This can lead to inefficient resource utilization, as the allocated memory may be either underutilized or insufficient for peak workloads.

Container orchestration platforms typically use resource metrics to make scaling decisions and optimize resource allocation. However, the static nature of JVM memory allocation can make it difficult for these platforms to accurately assess the true memory requirements of Java applications. This can result in suboptimal resource allocation decisions, potentially impacting application performance or leading to unnecessary resource consumption.

Vertical scaling, which involves adjusting the resources allocated to individual containers, is a common approach to optimizing resource utilization in containerized environments. However, implementing effective vertical scaling for Java applications requires careful consideration of the JVM's memory management behavior and its interaction with container-level resource constraints.

The ability to dynamically adjust memory allocation for Java applications in containerized environments could provide benefits in terms of resource efficiency and application performance. However, implementing such dynamic memory management presents technical challenges, including the need to coordinate between the JVM, the container runtime, and the orchestration platform.

Existing approaches to memory management in containerized Java applications often involve manual tuning of JVM parameters or static resource allocation at the container level. These methods may not adequately address the dynamic nature of modern application workloads or fully leverage the capabilities of container orchestration platforms.

There is a growing interest in developing more sophisticated approaches to memory management for Java applications in containerized environments. These approaches aim to better align JVM memory allocation with container-level resource management, potentially improving overall resource utilization and application performance.

### SUMMARY

In an embodiment, a method for dynamic heap resizing in Java workloads comprises: a memory; and a processor in communication with the memory, wherein the processor is configured to: allocate a predetermined percentage of the memory as a heap; monitor memory usage of the heap; and generate Vertical Pod Autoscaler (VPA) recommendations based on the monitored memory usage.

The processor may be further configured to automatically resize the heap based on the VPA recommendations.

In an embodiment, a Java Virtual Machine (JVM) may be configured to automatically resize the heap.

The JVM may be configured with options for tuning runtime behavior, wherein the options comprise maximum memory percentage, minimum memory percentage, and initial memory percentage.

The generate the VPA recommendations may comprise using a Workload Orchestration and Optimization Platform (WOOP) configured to generate the VPA recommendations based on the monitored memory usage and a policy.

The policy may comprise at least one of a memory limit multiplier or a memory percentile.

In an embodiment, the system may be implemented in a Kubernetes environment.

In an embodiment, a method for performing dynamic heap resizing in Java workloads comprises allocating, by a processor, a predetermined percentage of system memory as a heap; monitoring, by the processor, memory usage of the heap; and generating, by the processor, Vertical Pod Autoscaler (VPA) recommendations based on the monitored memory usage.

The method may further include automatically resizing, by the processor, the heap based on the VPA recommendations.

In an embodiment, a Java Virtual Machine (JVM) may be configured to automatically resize the heap.

The JVM may be configured with options for tuning runtime behavior, wherein the options comprise maximum memory percentage, minimum memory percentage, and initial memory percentage.

The generating the VPA recommendations may comprise using a Workload Orchestration and Optimization Platform (WOOP) configured to generate the VPA recommendations based on the monitored memory usage and a policy.

The policy may comprise at least one of a memory limit multiplier or a memory percentile.

In an embodiment, the method may be implemented in a Kubernetes environment.

In an embodiment, a non-transitory computer readable medium storing instructions for performing operations for dynamic heap resizing in Java workloads comprises allocating a predetermined percentage of system memory as a heap; monitoring memory usage of the heap; and generating Vertical Pod Autoscaler (VPA) recommendations based on the monitored memory usage.

The instructions may further include automatically resizing, by the processor, the heap based on the VPA recommendations.

In an embodiment, a Java Virtual Machine (JVM) may be configured to automatically resize the heap.

The JVM may be configured with options for tuning runtime behavior, wherein the options comprise maximum memory percentage, minimum memory percentage, and initial memory percentage.

The generating the VPA recommendations may comprise using a Workload Orchestration and Optimization Platform (WOOP) configured to generate the VPA recommendations based on the monitored memory usage and a policy.

The policy may comprise at least one of a memory limit multiplier or a memory percentile.

In an embodiment, the non-transitory computer readable medium may be implemented in a Kubernetes environment.

### BRIEF DESCRIPTION OF DRAWINGS

A general architecture that implements the various features of the disclosure will now be described with reference to the drawings. The drawings and the associated descriptions are provided to illustrate example embodiments of the disclosure and not to limit the scope of the disclosure. Throughout the drawings, reference numbers are reused to indicate correspondence between referenced elements.

FIG. 1 illustrates an example process flow 100 for performing dynamic heap resizing in Java workloads with some embodiments described herein.

FIG. 2 illustrates example JVM memory metrics in accordance with some embodiments described herein.

FIG. 3 illustrates an example computing environment with an example computer device suitable for use in some example embodiments.

### DETAILED DESCRIPTION

The following detailed description provides details of the figures and example embodiments of the present application. Reference numerals and descriptions of redundant elements between figures are omitted for clarity. Terms used throughout the description are provided as examples and are not intended to be limiting. For example, the use of the term “automatic” may involve fully automatic or semi-automatic embodiments involving user or administrator control over certain aspects of the embodiment, depending on the desired embodiment of one of the ordinary skills in the art practicing embodiments of the present application. Selection can be conducted by a user through a user interface or other input means, or can be implemented through a desired algorithm. Example embodiments as described herein can be utilized either singularly or in combination and the functionality of the example embodiments can be implemented through any means according to the desired embodiments.

The present disclosure relates to systems, methods, and computer-readable media for dynamic heap resizing in Java workloads. The system may include a Java Virtual Machine (JVM) and a Workload Orchestration and Optimization Platform (WOOP). The JVM may be configured to dynamically resize a Java heap based on memory usage, while the WOOP may monitor memory usage of the JVM and generate Vertical Pod Autoscaler (VPA) recommendations based on the monitored memory usage.

In some embodiments, a method for dynamic heap resizing in Java workloads may be provided. The method may involve configuring a JVM to dynamically resize a Java heap, monitoring memory usage of the JVM, and generating VPA recommendations based on the monitored memory usage.

Additionally, a non-transitory computer-readable medium storing instructions for dynamic heap resizing in Java workloads may be provided. When executed by a processor, these instructions may cause the processor to perform operations including initializing a JVM with configuration options for dynamic heap resizing, monitoring memory usage of the JVM during execution of a Java application and adjusting resource allocation based on the monitored memory usage using a VPA.

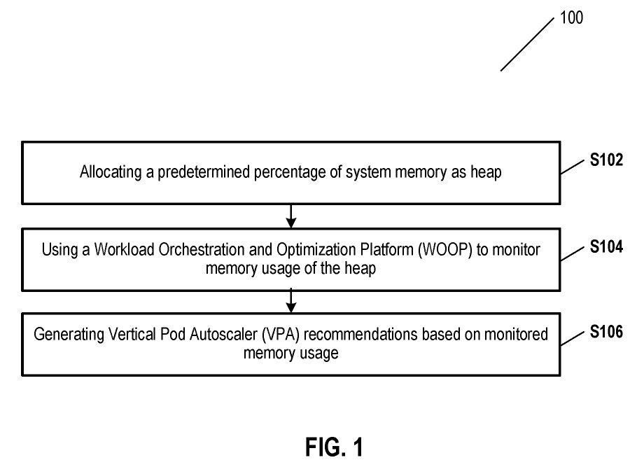

FIG. 1 illustrates an example process flow 100 for performing dynamic heap resizing in Java workloads with some embodiments described herein. The process begins at step S102 where a predetermined percentage of system memory is allocated as heap using JVM. The JVM may employ multiple heuristics for garbage collection, which may contribute to efficient memory utilization. In some embodiments, the JVM may be initialized with specific configuration options that enable dynamic heap resizing.

Several JVM options may be used to control heap allocation and management. These options may include: -XX:MaxRAMPercentage, -XX:MinRAMPercentage, and -XX:InitialRAMPercentage. The -XX:MaxRAMPercentage option may limit the JVM heap to a specified percentage of the system's available memory. For example, setting “-XX:MaxRAMPercentage=80” may allow the JVM to use up to 80% of the available system memory for the heap.

The -XX:MinRAMPercentage option may set the minimum percentage of system memory the JVM may reserve for its heap. For instance, “-XX:MinRAMPercentage=20” ensures that the JVM maintains at least 20% of the system memory for its heap.

The -XX:InitialRAMPercentage option may define the initial percentage of system memory allocated to the JVM heap at startup. As an example, “-XX:InitialRAMPercentage=50” may start the JVM with 50% of the available system memory allocated to the heap.

These percentage-based options allow the JVM to adjust its heap size dynamically based on the system's available memory. This approach may be particularly useful in containerized environments where the available memory may vary. In some embodiments, the JVM may be configured with the -XX:+UseG1GC option, which enables the Garbage-First (G1) garbage collector. The G1 collector may work in conjunction with the dynamic heap sizing options to optimize memory usage and application performance.

By configuring the JVM with these options, the Java heap may be dynamically resized based on memory usage. This dynamic resizing capability allows the JVM to allocate more memory when needed and release unused memory back to the system, which improves overall resource utilization.

At step S104, a Workload Orchestration and Optimization Platform (WOOP) may be utilized to monitor memory usage of the JVM. The WOOP may be configured to monitor the JVM's memory usage by tracking changes in heap size as the JVM allocates or deallocates memory. When the JVM increases the heap size by requesting additional memory from the operating system, the WOOP may detect an increase in the container's reported memory usage. Conversely, when the JVM reduces the heap size by returning unused memory to the operating system, the WOOP may observe a decrease in the container's reported memory usage.

Subsequently, the WOOP generates VPA recommendations based on monitored memory usage at step S106. These recommendations may be used to adjust resource allocation for Java workloads dynamically. In some embodiments, the WOOP may be modified to generate the Kubernetes memory limit and trigger the VPA recommendation process at regular intervals. For example, the VPA recommendation process may be triggered at predetermined intervals (e.g., every three minutes), with a 10-minute lookback period for analyzing memory usage patterns.

In some embodiments, the WOOP may be configured to generate VPA recommendations based on a configured policy. The WOOP policy may include various parameters for tuning memory recommendations. In some embodiments, these parameters may include, but not limited to, memory.limit.multiplier and memory.percentile. The “memory.limit.multiplier” parameter may adjust the memory limit based on a multiplier, while the “memory.percentile” parameter may determine memory recommendations based on a usage percentile.

The startupPeriod.seconds parameter may be included as part of the WOOP policy, which defines a startup period during which VPA recommendations may not be generated by the WOOP. This allows the Java application to stabilize its memory usage before adjustments are made.

In addition, the memory.percentile parameter may also be included as part of the WOOP policy. For instance, the parameter memory.percentile may be set to 0.90, indicating that the WOOP may base its recommendations on the 90th percentile of observed memory usage. This accounts for occasional spikes in memory usage without overprovisioning resources.

The memory.limit.multiplier parameter may be used to provide a buffer in the recommended memory limit. For example, setting memory.limit.multiplier to 1.1 may result in VPA recommendations that are 10% higher than the observed memory usage, providing headroom for potential increases in memory demand.

By monitoring JVM memory usage and generating VPA recommendations based on configurable policies, the WOOP may help optimize resource allocation for Java workloads in containerized environments. This allows for more efficient use of system resources while maintaining application performance and stability.

The VPA may take different actions based on various memory usage scenarios. For instance:

High memory usage: If WOOP reports that the JVM is consistently using more than 80% of its allocated memory, the VPA may recommend increasing the memory limit by a predetermined percentage, such as 20%.

Low memory usage: If WOOP detects that the JVM is consistently using less than 50% of its allocated memory, the VPA may recommend decreasing the memory limit to optimize resource allocation. In some embodiments, the memory limit may be reduced by a predetermined amount or percentage.

Fluctuating memory usage: In scenarios where memory usage fluctuates significantly, the VPA may use the memory.percentile parameter from the WOOP policy to determine an appropriate memory limit that accommodates most usage patterns without overprovisioning. In some embodiments, the appropriate memory limit may be derived from an Artificial Intelligence (AI)/Machine Learning (ML) model that has been trained using historical memory limits and associated inputs. The AI/ML model may include, but not limited to, convolutional neural network (CNN), recurrent neural network (RNN), deep RNN (DRNN), Q-learning network (QN), deep Q-learning network (DQN), linear regression, decision trees, K-Nearest Neighbors, etc.

By leveraging the recommendations from WOOP and adjusting resource allocation dynamically, the VPA may help optimize the performance and efficiency of Java workloads in containerized environments. This approach may allow for more efficient use of cluster resources while maintaining application stability and performance. In some cases, the system for dynamic heap resizing in Java workloads may be implemented in a Kubernetes environment. Kubernetes, a container orchestration platform, may provide mechanisms or resources for managing and scaling containerized applications, including Java workloads.

In some embodiments, the system may use Kubernetes labels and annotations to fine-tune the behavior of dynamic heap sizing for specific Java workloads. These labels and annotations may provide additional context for the WOOP and VPA to generate more accurate recommendations based on the characteristics of individual applications.

The integration with Kubernetes may also enable the system to handle scenarios such as pod evictions or node failures more gracefully. By dynamically adjusting the heap size based on available resources, Java applications may be able to continue functioning even when moved to nodes with different memory configurations.

In some embodiments, the system may leverage Kubernetes resource quotas and limit ranges to ensure that dynamic heap sizing does not interfere with overall cluster resource management policies. This integration may help maintain a balance between optimizing individual Java workloads and ensuring fair resource distribution across the entire Kubernetes cluster.

In some embodiments, the system may be enhanced by injecting JAVA_OPTS into the container using the VPA. This enhancement may allow for dynamic adjustment of JVM parameters based on currently available resources and workload characteristics.

In some embodiments, the process of dynamic heap resizing may be obfuscated to prevent reverse engineering. Example obfuscation techniques may include, but not limited to, randomizing the timing of heap size adjustments, noise insertion, encrypting communication between system components, etc. These obfuscation techniques help protect the system's proprietary algorithms and prevent potential exploitation of its resource allocation strategies.

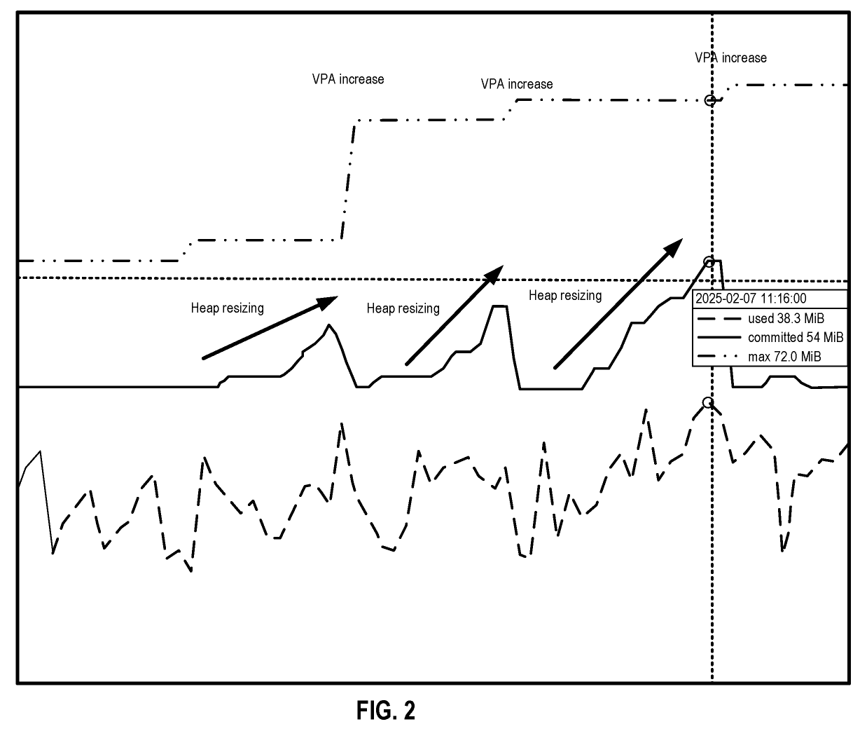

FIG. 2 illustrates example JVM memory metrics in accordance with some embodiments described herein. Three memory metrics are illustrated in FIG. 2 and these include: used, committed, and max. Used is associated with actual or near actual memory usage as observed. Committed is the resized memory based on resizing recommendations based on observed memory usage. As shown in FIG. 2, the JVM may allocate or deallocate heap memory based on demand. Resizing recommendations may be triggered at predetermined intervals (e.g., every three minutes), with a 10-minute lookback period for analyzing memory usage patterns. Max is a percentage of maximum allocable memory, which increases as demand for heap memory increases.

The foregoing example embodiments may have various benefits and advantages. For example, the systems, methods, and computer-readable media described herein may provide improved memory management for Java workloads in containerized environments. By dynamically resizing the Java heap and generating accurate VPA recommendations, these embodiments may help optimize resource allocation and improve overall system performance.

Specifically, by dynamically adjusting heap size and container resource limits, the system may (i) reduce out-of-memory errors by allocating additional resources when needed; (ii) improve resource utilization by releasing unused memory back to the system; (iii) optimize application performance by maintaining an appropriate balance between heap size and available system resources; and (iv) enhance cluster efficiency by allowing for more accurate resource allocation across multiple Java workloads.

In addition, the JVM may be configured for dynamic heap resizing to optimize memory usage in Java workloads. Specifically, the JVM may utilize various options for tuning runtime behavior, particularly in the realm of memory management. Further, the system may adapt its behavior based on the specific characteristics of the Java application and the Kubernetes environment. This adaptation may involve adjusting monitoring intervals, modifying VPA recommendation thresholds, or fine-tuning JVM options based on observed performance patterns.

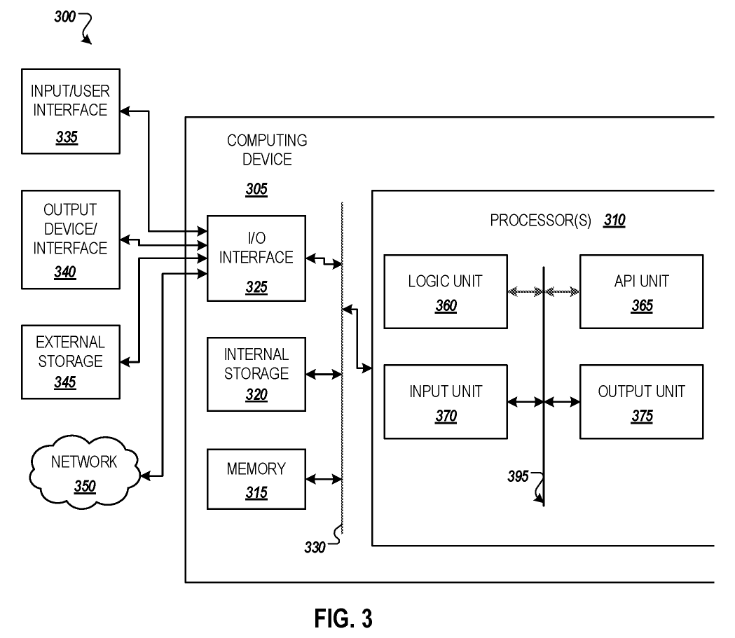

FIG. 3 illustrates an example computing environment with an example computer device suitable for use in some example embodiments. Computer device 305 in computing environment 300 can include one or more processing units, cores, or processors 310, memory 315 (e.g., RAM, ROM, and/or the like), internal storage 320 (e.g., magnetic, optical, solid-state storage, and/or organic), and/or IO interface 325, any of which can be coupled on a communication mechanism or bus 330 for communicating information or embedded in the Computer device 305. IO interface 325 is also configured to receive images from cameras or provide images to projectors or displays, depending on the desired embodiment.

Computer device 305 can be communicatively coupled to input/user interface 335 and output device/interface 340. Either one or both of the input/user interface 335 and output device/interface 340 can be a wired or wireless interface and can be detachable. Input/user interface 335 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 340 may include a display, television, monitor, printer, speaker, braille, or the like. In some example embodiments, input/user interface 335 and output device/interface 340 can be embedded with or physically coupled to the computer device 305. In other example embodiments, other computer devices may function as or provide the functions of input/user interface 335 and output device/interface 340 for a computer device 305.

Examples of computer device 305 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 305 can be communicatively coupled (e.g., via IO interface 325) to external storage 345 and network 350 for communicating with any number of networked components, devices, and systems, including one or more computer devices of the same or different configuration. Computer device 305 or any connected computer device can be functioning as, providing services of, or referred to as a server, client, thin server, general machine, special-purpose machine, or another label.

IO interface 325 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 300. Network 350 can be any network or combination of networks (e.g., the Internet, local area network, wide area network, a telephonic network, a cellular network, satellite network, and the like).

Computer device 305 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 305 can be used to implement techniques, methods, applications, processes, or computer-executable instructions in some example computing environments. Computer-executable instructions can be retrieved from transitory media and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 310 can execute under any operating system (OS) (not shown), in a native or virtual environment. One or more applications can be deployed that include logic unit 360, application programming interface (API) unit 365, input unit 370, output unit 375, and inter-unit communication mechanism 395 for the different units to communicate with each other, with the OS, and with other applications (not shown). The described units and elements can be varied in design, function, configuration, or embodiment and are not limited to the descriptions provided. Processor(s) 310 can be in the form of hardware processors such as central processing units (CPUs) or in a combination of hardware and software units.

In some example embodiments, when information or an execution instruction is received by API unit 365, it may be communicated to one or more other units (e.g., logic unit 360, input unit 370, output unit 375). In some instances, logic unit 360 may be configured to control the information flow among the units and direct the services provided by API unit 365, the input unit 370, the output unit 375, in some example embodiments described above. For example, the flow of one or more processes or embodiments may be controlled by logic unit 360 alone or in conjunction with API unit 365. The input unit 370 may be configured to obtain input for the calculations described in the example embodiments, and the output unit 375 may be configured to provide an output based on the calculations described in example embodiments.

Processor(s) 310 can be configured to allocate a predetermined percentage of system memory as a heap as illustrated in FIGS. 1 and FIG. 2. The processor(s) 310 may also be configured to monitor memory usage of the heap as illustrated in FIGS. 1 and FIG. 2. The processor(s) 310 may also be configured to generate Pod Autoscaler (VPA) recommendations based on the monitored memory usage as illustrated in FIGS. 1 and FIG. 2. The processor(s) 310 may also be configured to automatically resize the heap based on the VPA recommendations as illustrated in FIGS. 1 and FIG. 2.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example embodiments, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system’s registers and memories into other data similarly represented as physical quantities within the computer system’s memories or registers or other information storage, transmission or display devices.

Example embodiments may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software embodiments that involve instructions that perform the operations of the desired embodiment.

Various general-purpose systems may be used with programs and modules in accordance with the examples herein, or it may prove convenient to construct a more specialized apparatus to perform desired method steps. In addition, the example embodiments are not described with reference to any particular programming language. It will be appreciated that a variety of programming languages may be used to implement the teachings of the example embodiments as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example embodiments may be implemented using circuits and logic devices (hardware), while other aspects may be implemented using instructions stored on a machine-readable medium (software), which if executed by a processor, would cause the processor to perform a method to carry out embodiments of the present application. Further, some example embodiments of the present application may be performed solely in hardware, whereas other example embodiments may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other embodiments of the present application will be apparent to those skilled in the art from consideration of the specification and practice of the teachings of the present application. Various aspects and/or components of the described example embodiments may be used singly or in any combination. It is intended that the specification and example embodiments be considered as examples only, with the true scope and spirit of the present application being indicated by the following claims.

What is claimed is:

1. A system for dynamic heap resizing in Java workloads, comprising:
a memory; and
a processor in communication with the memory, wherein the processor is configured to:
allocate a predetermined percentage of the memory as a heap;
monitor memory usage of the heap; and
generate Vertical Pod Autoscaler (VPA) recommendations based on the monitored memory usage.

2. The system of claim 1, wherein the processor is further configured to:
automatically resize the heap based on the VPA recommendations.

3. The system of claim 2, wherein a Java Virtual Machine (JVM) is configured to automatically resize the heap.

4. The system of claim 3, wherein the JVM is configured with options for tuning runtime behavior,
wherein the options comprise maximum memory percentage, minimum memory percentage, and initial memory percentage.

5. The system of claim 1, wherein the generate the VPA recommendations comprises using a Workload Orchestration and Optimization Platform (WOOP) configured to generate the VPA recommendations based on the monitored memory usage and a policy.

6. The system of claim 5, wherein the policy comprises at least one of a memory limit multiplier or a memory percentile.

7. The system of claim 1, wherein the system is implemented in a Kubernetes environment.

8. A method for performing dynamic heap resizing in Java workloads, the method comprising:
allocating, by a processor, a predetermined percentage of system memory as a heap;
monitoring, by the processor, memory usage of the heap; and
generating, by the processor, Vertical Pod Autoscaler (VPA) recommendations based on the monitored memory usage.

9. The method of claim 8, further comprising:
automatically resizing, by the processor, the heap based on the VPA recommendations.

10. The method of claim 9, wherein a Java Virtual Machine (JVM) is configured to automatically resize the heap.

11. The method of claim 10, wherein the JVM is configured with options for tuning runtime behavior,
wherein the options comprise maximum memory percentage, minimum memory percentage, and initial memory percentage.

12. The method of claim 8, wherein the generating the VPA recommendations comprises using a Workload Orchestration and Optimization Platform (WOOP) configured to generate the VPA recommendations based on the monitored memory usage and a policy.

13. The method of claim 12, wherein the policy comprises at least one of a memory limit multiplier or a memory percentile.

14. The method of claim 8, wherein the method is implemented in a Kubernetes environment.

15. A non-transitory computer-readable medium storing instructions that, when executed by a processor, cause the processor to perform operations for dynamic heap resizing in Java workloads, the operations comprising:
allocating a predetermined percentage of system memory as a heap;
monitoring memory usage of the heap; and
generating Vertical Pod Autoscaler (VPA) recommendations based on the monitored memory usage.

16. The non-transitory computer-readable medium of claim 15, further comprising:
automatically resizing, by the processor, the heap based on the VPA recommendations.

17. The non-transitory computer-readable medium of claim 16, wherein a Java Virtual Machine (JVM) is configured to automatically resize the heap.

18. The non-transitory computer-readable medium of claim 17, wherein the JVM is configured with options for tuning runtime behavior,
wherein the options comprise maximum memory percentage, minimum memory percentage, and initial memory percentage.

19. The non-transitory computer-readable medium of claim 15, wherein the generating the VPA recommendations comprises using a Workload Orchestration and Optimization Platform (WOOP) configured to generate the VPA recommendations based on the monitored memory usage and a policy.

20. The non-transitory computer-readable medium of claim 19, wherein the policy comprises at least one of a memory limit multiplier or a memory percentile.
